(19) United States
(12) Patent Application Publication
(10) Pub. No.: US 2022/0018190 A1
(43) Pub. Date: Jan. 20, 2022

(54) Smart Safety Ladder

(71) Applicant: Rafael Gonzalez, Surprise, AZ (US)

(72) Inventor: Rafael Gonzalez, Surprise, AZ (US)

(21) Appl. No.: 16/932,676

(22) Filed: Jul. 17, 2020

(51) Int. Cl. E06C 7/00; E06C 7/50

(52) U.S. Cl. CPC E06C 7/003; E06C 1/18; E06C 7/50

(57) ABSTRACT

The smart safety ladder is an electronic safety device installed to standard construction ladders to prevent misuse of the ladder and ultimately keep workers safe. The top two rungs of the ladder are equipped with motion sensors that once triggered, turn on a red light and a beeping warning. Another safety feature is a motion sensor and level sensor on the bottom rung that will trigger a green light and an audible sound that will notify the person that he or she is on the bottom step. The smart safety ladder has an on and off switch which will activate and deactivate the ladder's electronic sensors, lights, and alarm system when you open and close the A frame ladder. A safety lock switch may be used to keep the ladder locked in place in fully open position. The smart electrical safety system can be installed on all standard construction ladders.

### BACKGROUND

In each work place there is a possibility of work related injury. In construction and manual labor related industries possible work related injuries may be due to failure of machinery, tools, or equipment; misuse of machinery, tools, or equipment; or repetitive strain from using machinery, tools, or equipment. Most common accidents and injuries in the workplace include: slips, trips, falls, muscle strain from repetitive work, being hit by falling objects, crashes, collisions, cuts and lacerations, inhaling toxic fumes, exposure to loud noise and walking into objects. It is probable that by following safety precautions and procedures many of these injury incidents could be avoided.

A common tool used in the construction and related manual labor industries is a ladder. A ladder is a vertical or inclined set of rungs or steps. There are two types of ladders: self-supporting ladders that are placed on the ground and rollable ladders made of rope or other material that are hung down from the top of something. A ladder may be fixed onto a specific place such as a building, structure, or equipment or the ladder may be rigid and portable. The most common injury sustained by a person using a ladder is bruising from falling off a ladder, but bone fractures are common and head injuries are also likely, depending on the nature of the accident. Ladders can slip backwards owing to faulty base pads or improper leaning ladder angle.

There exists a need for a Smart Safety Ladder that is not being met by any known or disclosed device or system of present.

### SUMMARY OF THE INVENTION

The smart safety ladder is an electronic safety device installed to standard construction ladders to prevent misuse of the ladder and ultimately keep workers safe. The top two rungs of the ladder are equipped with motion sensors that, once triggered, turn on a red light and a beeping warning. Another safety feature is a motion sensor on the bottom rung that will trigger a green light and an audible sound that will notify the person that he or she is on the bottom step. The smart safety ladder has an on and off switch which will activate and deactivate the ladder's electronic sensors, lights, and alarm system when you open and close the A frame ladder. A safety lock switch may be used to keep the ladder locked in place in fully open position. The smart electrical safety system can be installed on all standard construction ladders.

### BRIEF DESCRIPTION OF THE DRAWINGS

FIG. 1 is a depiction of the perspective view of the safety ladder in accordance with an embodiment of the present disclosure.

FIG. 2 depicts a method for making a ladder safe via motion and level sensors and audio visual alarms in accordance with an embodiment of the disclosure.

FIG. 3 depicts an accompanying method for making a ladder safe via motion and level sensors and audio visual alarms in accordance with an embodiment of the disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term “smart” refers to electronic elements or features that may or may not be automatic added to a previously non-electronic item. The term “safety” refers to elements or features that are meant to reduce the risk of property damage, accident, and personal injury due to accidental or intentional misuse of the ladder. The term “top cap” is used to refer to the top horizontal and corresponding vertical sides of the ladder above the top rung or step.

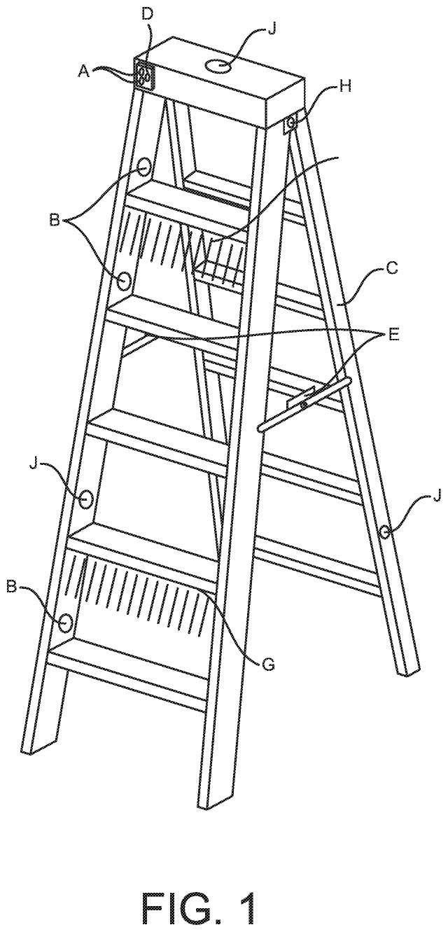

FIG. 1 is a depiction of the perspective view of the safety ladder in accordance with an embodiment of the present disclosure. The safety ladder is comprised of a construction ladder C regularly used in construction and such activities with the following special features: lights activated by motion sensor, motion sensors, beeping alarm speaker activated by motion sensor D, mechanical switch E, and an on/off button H. The mechanical switch E is placed on both sides of the spreaders. The on/off button H is placed on the top of the side rail near the top cap of the ladder. The beeping alarm speaker D is located on the top cap of the ladder to the side of the alarm lights.

The motion sensors respond to a person using the ladder to provide safety features including audible alarm and colored alarm lights to ensure the ladder is being used properly and to protect the user from accident. There are motion sensors in three places. Motion sensors are placed in the inside of the front side rails above and below the top step and above the first step.

In an embodiment of the disclosure, the lights at various places on the ladder visually warn the person when he or she are using the ladder improperly. There are lights in four places on the ladder. A red light and a green light A, activated by motion sensors, are placed on the vertical edge of the top cap of the ladder. A red strip light F is placed underneath the bottom of the top step. Additionally, there is a green strip light G located underneath the second step of the ladder.

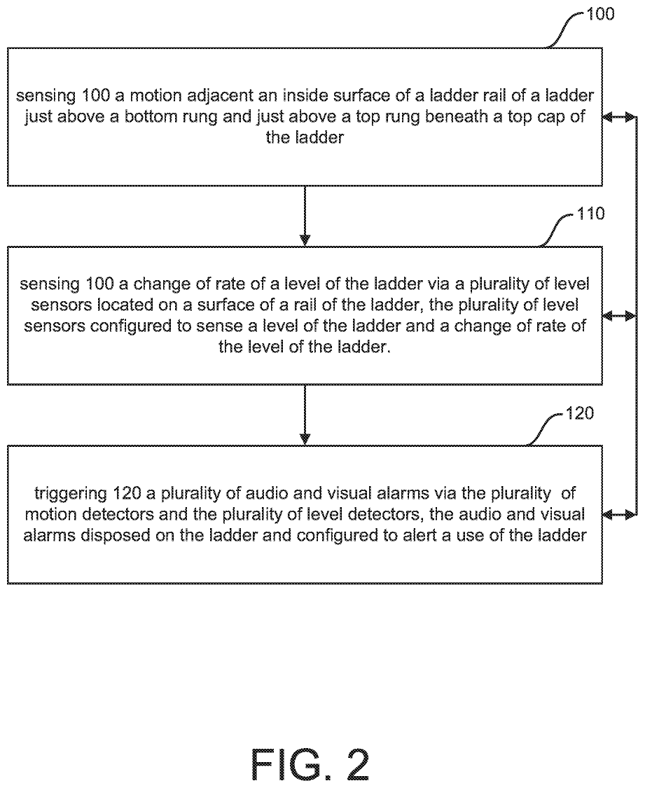

FIG. 2 depicts a method for making a ladder safe via motion and level sensors and audio visual alarms in accordance with an embodiment of the disclosure. The method includes sensing 100 a motion adjacent an inside surface of a ladder rail of a ladder just above a bottom rung and just above a top rung beneath a top cap of the ladder. The method also includes sensing 110 a change of rate of a level of the ladder via a plurality of level sensors located on a surface of a rail of the ladder, the plurality of level sensors configured to sense a level of the ladder and a change of rate of the level of the ladder. The method additionally includes triggering 120 a plurality of audio and visual alarms via the plurality of motion detectors and the plurality of level detectors, the audio and visual alarms disposed on the ladder and configured to alert a use of the ladder. The method further includes mechanically locking 130 at least one moveable part of the ladder via a lock configured to keep the ladder in a configuration while in use and until the user unlocks the lock to change the configuration of the ladder.

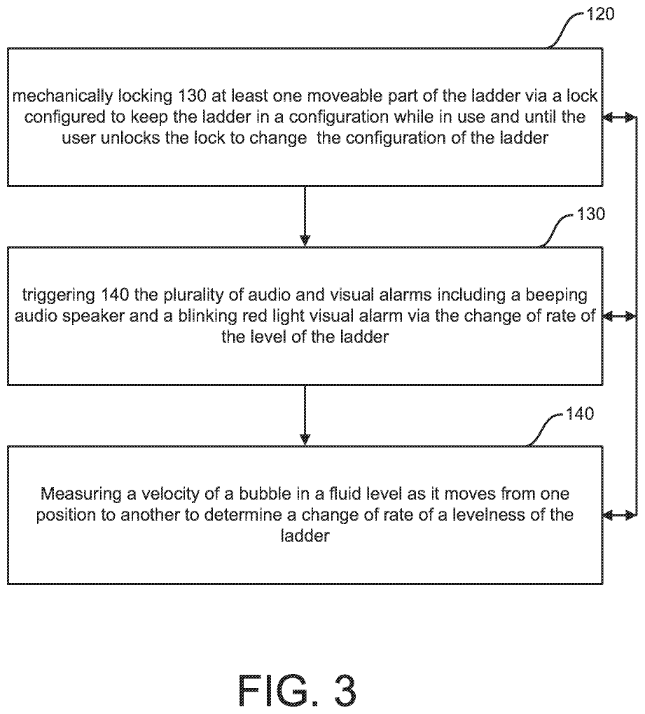

FIG. 3 depicts an accompanying method for making a ladder safe via motion and level sensors and audio visual alarms in accordance with an embodiment of the disclosure. The accompanying embodied methods include locating the plurality of motion sensors on an inside surface of a ladder rail just above a second-to-top rung beneath a top cap of the ladder. Embodied methods also include triggering 140 the plurality of audio and visual alarms including a beeping audio speaker and a blinking red light visual alarm via the change of rate of the level of the ladder. Embodied methods additionally include sensing the change of rate of a level of the ladder with respect to a first front rail and a second front rail of the ladder and with respect to a front rail and a back rail of the ladder in a “A frame,” step ladder configuration. For instance, measuring 150 a velocity of a bubble in a fluid level as it moves from one position to another is used to determine a change of rate of a levelness of the ladder. Similar techniques are used in a laser level and a change of rate of levelness. Therefore, the method includes sensing a change in velocity of a movement of a bubble in a fluid level to trigger the plurality of audio and visual alarms that a dangerous tipping of the ladder is commencing.

Embodiments further include triggering the plurality of audio and visual alarms including a beeping audio speaker and a green light visual alarm and a red light respectively via the motion sensor located just above the bottom rung and just above the top rung below the top cap of the ladder. Embodiments yet include sensing the change of rate of a level of the ladder via a capacitance of a fluid in the plurality of level sensors at a predetermined point in the plurality of level sensors and via a laser through a fluid in the plurality of level sensors at a predetermined point in the plurality of level sensors.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A safety ladder comprising:
a plurality of motion sensors located on an inside surface of a ladder rail just above a bottom rung and just above a top rung beneath a top cap of the ladder;
a plurality of level sensors located on a surface of the ladder rail, the plurality of level sensors configured to sense a level of the ladder and a change of rate of the level of the ladder;
a plurality of audio and visual alarms disposed on the ladder and triggered by the plurality of motion detectors and the plurality of level detectors and configured to alert a user and others to a use of the ladder; and
a mechanical lock on at least one moveable part of the ladder, the lock configured to keep the ladder in a configuration while in use and until the user unlocks the lock to change the configuration of the ladder.

2. The safety ladder of claim 1, wherein the plurality of motion sensors further include a motion sensor located on an inside surface of a ladder rail just above a second-to-top rung beneath a top cap of the ladder.

3. The safety ladder of claim 1, wherein the plurality of audio and visual alarms include a beeping audio speaker and a blinking red light visual alarm triggered by the change of rate of the level of the ladder.

4. The safety ladder of claim 1, wherein the plurality of level sensors sense a level with respect to a first front rail and a second front rail of the ladder and with respect to a front rail and a back rail of the ladder in a “A frame,” step ladder configuration.

5. The safety ladder of claim 1, wherein the plurality of audio and visual alarms include a beeping audio speaker and a green light visual alarm triggered by the motion sensor located just above the bottom rung.

6. The safety ladder of claim 1, wherein the plurality of audio and visual alarms include a beeping audio speaker and a blinking red light visual alarm triggered by the motion sensor located just above the top rung below the top cap of the ladder.

7. The safety ladder of claim 1, wherein the at least one moveable part of the ladder is a spreader located between a front rail and a back rail of an “A frame,” step ladder.

8. The safety ladder of claim 1, wherein the at least one moveable part of the ladder is a rung lock of an extension ladder.

9. The safety ladder of claim 1, wherein the plurality of audio and visual alarms include a beeping audio speaker and a blinking red light visual alarm triggered by a motion sensor located on an inside surface of a ladder rail just above a second-to-top rung beneath a top cap of the ladder

10. The safety ladder of claim 1, wherein the change of rate of a level of the ladder is sensed via a capacitance of a fluid in the plurality of level sensors at a predetermined point in the plurality of level sensors.

11. The safety ladder of claim 1, wherein the change of rate of the level of the ladder is sensed via a laser through a fluid in the plurality of level sensors at a predetermined point in the plurality of level sensors.

12. A method of making a ladder safe, the method comprising:
sensing a motion adjacent an inside surface of a ladder rail of a ladder just above a bottom rung and just above a top rung beneath a top cap of the ladder;
sensing a change of rate of a level of the ladder via a plurality of level sensors located on a surface of a rail of the ladder, the plurality of level sensors configured to sense a level of the ladder and a change of rate of the level of the ladder;
triggering a plurality of audio and visual alarms via the plurality of motion detectors and the plurality of level detectors, the audio and visual alarms disposed on the ladder and configured to alert a use of the ladder; and
mechanically locking at least one moveable part of the ladder via a lock configured to keep the ladder in a configuration while in use and until the user unlocks the lock to change the configuration of the ladder.

13. The method of claim 12, further comprising locating the plurality of motion sensors on an inside surface of a ladder rail just above a second-to-top rung beneath a top cap of the ladder.

14. The method of claim 12, further comprising triggering the plurality of audio and visual alarms including a beeping audio speaker and a blinking red light visual alarm via the change of rate of the level of the ladder.

15. The method of claim 12, further comprising sensing the change of rate of a level of the ladder with respect to a first front rail and a second front rail of the ladder and with respect to a front rail and a back rail of the ladder in a “A frame,” step ladder configuration.

16. The method of claim 12, further comprising triggering the plurality of audio and visual alarms including a beeping audio speaker and a green light visual alarm via the motion sensor located just above the bottom rung.

17. The method of claim 12, further comprising triggering the plurality of audio and visual alarms including a beeping audio speaker and a blinking red light visual alarm via the motion sensor located just above the top rung below the top cap of the ladder.

18. The method of claim 12, further comprising sensing a change in velocity of a movement of a bubble in a fluid level to trigger the plurality of audio and visual alarms that a dangerous tipping of the ladder is commencing.

19. The method of claim 12, further comprising sensing the change of rate of a level of the ladder via a capacitance of a fluid in the plurality of level sensors at a predetermined point in the plurality of level sensors.

20. The method of claim 12, further comprising sensing the change of rate of the level of the ladder via a laser through a fluid in the plurality of level sensors at a predetermined point in the plurality of level sensors.
